(19) United States
(12) Patent Application Publication
(10) Pub. No.: US 2023/0067098 A1
(43) Pub. Date: Mar. 2, 2023

(54) CONTROLLER AND PROGRAM

(71) Applicant: FANUC CORPORATION, Yamanashi (JP)

(72) Inventor: Takashi KAWAIDA, Yamanashi (JP)

(73) Assignee: FANUC CORPORATION, Yamanashi (JP)

(21) Appl. No.: 17/759,994

(22) PCT Filed: Mar. 12, 2021
(86) PCT No.: PCT/JP2021/010134

§ 371 Date: Aug. 2, 2022

(30) Foreign Application Priority Data
Mar. 18, 2020 (JP) 2020-047521

(51) Int. Cl. B25J 9/16; B25J 13/08

(52) U.S. Cl. CPC B25J 9/1633; B25J 9/1638; B25J 9/1664; B25J 13/085

(57) ABSTRACT

Provided are a controller and a program which optimize specifications of a motor, thereby enabling a reduction in costs related to an industrial robot. This controller controls a multi-axis robot for holding a workpiece and comprises: a planned operation angle position acquisition unit which acquires a planned operation angle position of the motor for each axis on the basis of a planned movement position of the workpiece; a torque calculation unit which calculates a load torque applied from the workpiece to the motor 140 on the basis of a load weight relating to the workpiece and a horizontal distance from the axial center of each axis to the workpiece; and a movement possibility determination unit which determines whether or not the motor can be moved to the planned operation angle position on the basis of a difference between the calculated load torque and an allowable torque of the motor.

### TECHNICAL FIELD

The present disclosure relates to a controller and a program.

### BACKGROUND ART

Conventionally, for example, a multi-axis robot including a plurality of motors arranged therein has been known as an industrial robot. Specifically, as such an industrial robot, a multi-axis robot in which six axes are arranged has been known. In many cases, an operating area of the industrial robot is defined such that its flange center position (end effector mounting position) can reach a more distant range. For example, for the industrial robot, an area including a range corresponding to a posture in which an arm of the robot is fully extended is often defined as the operating area in order to secure a wider operating area.

However, a large moment acts around a predetermined axis in the posture in which the arm is fully extended. Even in this posture, it is necessary to grip a rated workpiece and select a motor of a predetermined axis such that a predetermined operation can be achieved. In a case where the motor selected in this way is used, the moment around the predetermined axis decreases in a state where the arm is withdrawn. In this case, performance of the motor of the predetermined axis becomes over-spec. Therefore, a controller has been proposed that makes it possible to transfer a workpiece by changing a posture according to the weight of a workpiece to be gripped (for example, see Patent Document 1).
Patent Document 1: Japanese Unexamined Patent Application, Publication No. H10-264064

### DISCLOSURE OF THE INVENTION

### Problems to be Solved by the Invention

In Patent Document 1, the controller compares the weight of a detected workpiece with the load that can be transferred by a robot arm in a current posture. When the weight of the workpiece is greater than the load that can be transferred by the robot arm in the current posture, the controller changes the posture of the robot arm to a posture in which the workpiece can be transferred. Thus, the controller makes it possible to transfer the workpiece.

Meanwhile, in the case of the multi-axis robot, it is preferable to calculate a load on the motor for each axis. Therefore, it is suitable to optimize the selection of the motor for a rated load in this way. It is suitable if reduction in costs of the industrial robot can be achieved by optimization of the selection of the motor.

### Means for Solving the Problems

(1) The present disclosure provides a controller that controls a multi-axis robot configured to hold a workpiece, the controller including: a planned operation angle position acquisition unit that acquires a planned operation angle position of a motor of each axis, based on a planned movement position of the workpiece; a torque calculation unit that calculates a load torque applied from the workpiece to the motor, based on a load weight of the workpiece and a horizontal distance from an axial center of each axis to the workpiece; and a movement enabling/disabling determination unit that determines, based on a difference between calculated load torque and an allowable torque of the motor, whether to allow the motor to move to the planned operation angle position.

(2) The present disclosure provides a program that causes a computer to operate as a controller of a multi-axis robot configured to hold a workpiece, the program causing the computer to function as: a planned operation angle position acquisition unit that acquires a planned operation angle position of a motor of each axis, based on a planned movement position of the workpiece; a torque calculation unit that calculates a load torque applied from the workpiece to the motor, based on a load weight of the workpiece and a horizontal distance from an axial center of each axis to the workpiece; and a movement enabling/disabling determination unit that determines, based on a difference between calculated load torque and an allowable torque of the motor, whether to allow the motor to move to the planned operation angle position.

### Effects of the Invention

According to the present disclosure, it is possible to provide a controller and a program capable of reducing costs of an industrial robot by optimizing selection of the motor.

### BRIEF DESCRIPTION OF THE DRAWINGS

FIG. 1 is a schematic diagram showing a constitution of a multi-axis robot that is controlled by a controller according to an embodiment of the present disclosure;

FIG. 2 is a graph showing a load weight and a reachable position of a flange center in the case of the multi-axis robot that is controlled by the controller according to the embodiment;

FIG. 3 is a block diagram showing a configuration of the controller according to the embodiment;

FIG. 4 is a schematic diagram showing a configuration of the multi-axis robot that is controlled by the controller according to the embodiment;

FIG. 5 is a schematic diagram showing, as an example, a distance from an axial position to a flange and a motion range of the multi-axis robot that is controlled by the controller according to the embodiment;

FIG. 6 is a flowchart showing a flow of processes performed by the controller according to the embodiment; and

FIG. 7 is a schematic diagram showing a configuration of a controller according to a modification.

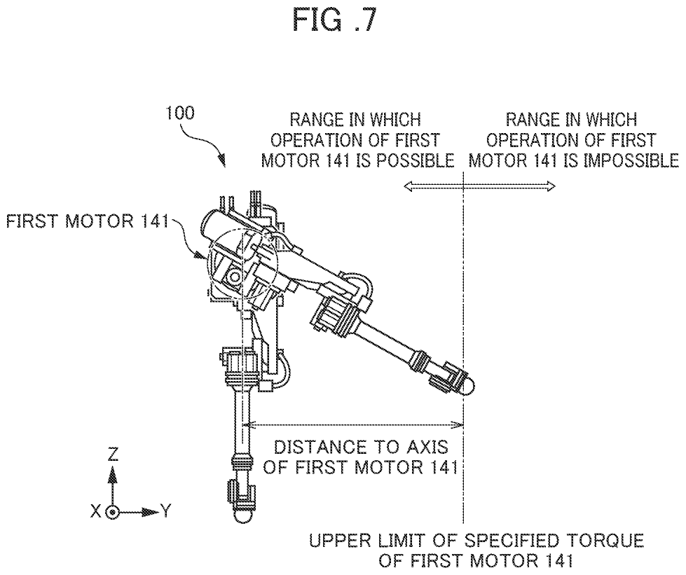

### PREFERRED MODE FOR CARRYING OUT THE INVENTION

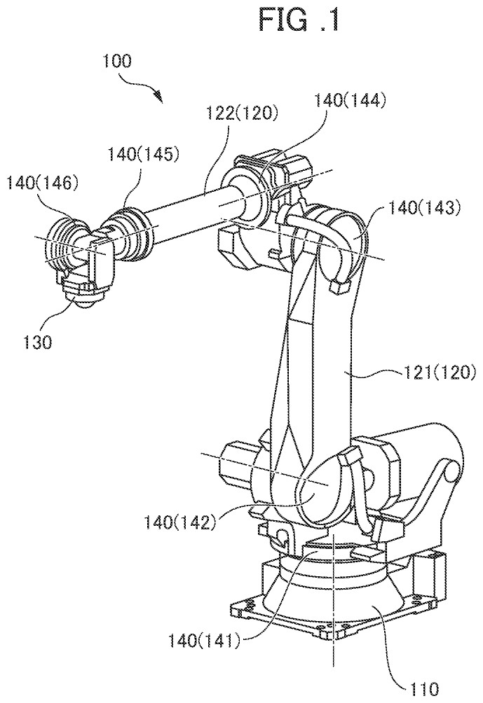

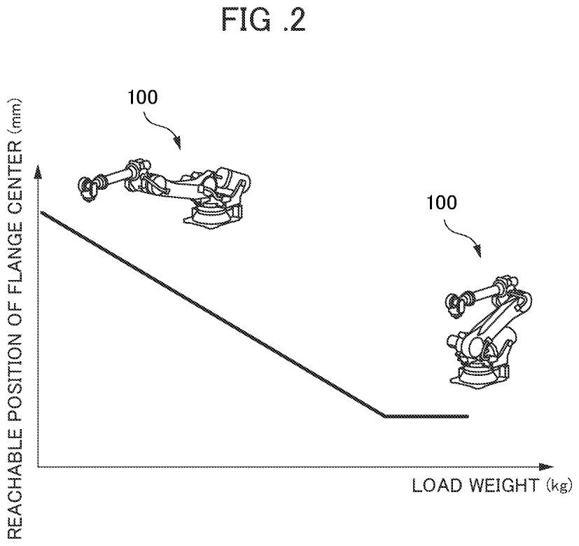

A controller 1 and a program according to an embodiment of the present disclosure will be described with reference to FIGS. 1 to 6. First, prior to a description of the controller 1 of the present embodiment, an industrial robot (multi-axis robot 100) that is controlled by the controller 1 will be described with reference to FIGS. 1 and 2.

As shown in FIG. 1, the multi-axis robot 100 is a robot arm having a large number of axes. The multi-axis robot 100 is, for example, a robot arm having six axes. The multi-axis robot 100 includes a base portion 110, an arm portion 120, a mounting portion 130, and motors 140.

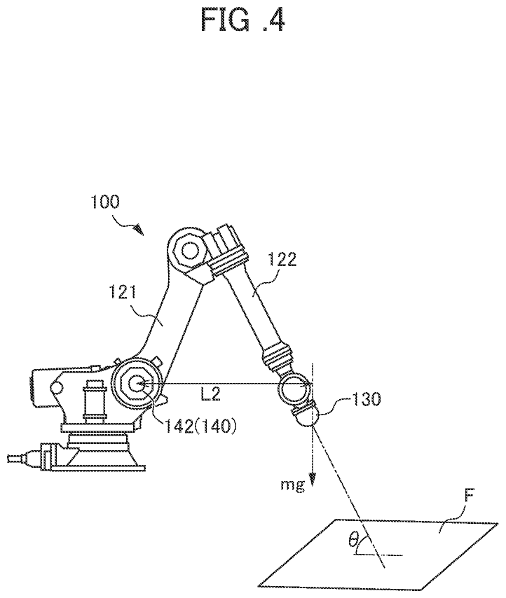

The base portion 110 is, for example, a pedestal that is brought into contact with an arrangement surface F (see FIG. 4) on which the multi-axis robot 100 is arranged. In the following description, the base portion 110 is fixed to the arrangement surface F.

The arm portion 120 is a rod-shaped member mounted to the base portion 110 and is bendable. The arm portion 120 includes a first arm portion 121 and a second arm portion 122.

The first arm portion 121 is a rod-shaped member. The first arm portion 121 is connected to the base portion 110 at one end. The second arm portion 122 is a rod-shaped member. The second arm portion 122 is connected to the first arm portion 121 at one end.

The mounting portion 130 is connected to the other end of the second arm portion 122. The mounting portion 130 is configured such that an end effector (not shown) can be attached to the mounting portion 130. In the following embodiment, a center position (coordinates) of the mounting portion 130 is used as a reaching position of a distal end of the arm portion 120 of the multi-axis robot. The mounting portion 130 has a flange shape. For example, the mounting portion 130 is arranged such that its axial direction is directed to the other end of the second arm portion 122.

The motors 140 are, for example, direct drive motors. The motors 140 include two motors arranged at the base portion 110 and the first arm portion 121, two motors arranged at the first arm portion 121 and the second arm portion 122, and two motors arranged at the second arm portion 122 and the mounting portion 130. Specifically, the motors 140 arranged at the base portion 110 and the first arm portion 121 have their axial directions intersecting with each other, the motors 140 arranged at the first arm portion 121 and the second arm portion 122 have their axial directions intersecting with each other, and the motors 140 arranged at the second arm portion 122 and the mounting portion 130 have their axial directions intersecting with each other. In the following embodiment, the motors 140 include six motors, namely, a first motor 141, a second motor 142, a third motor 143, a fourth motor 144, a fifth motor 145, and a sixth motor 146.

The first motor 141 is arranged at a position where the base portion 110 is connected to the first arm portion 121. The first motor 141 is arranged with its axis oriented in a vertical direction. The second motor 142 is arranged at a position where the base portion 110 is connected to the first arm portion 121. The second motor 142 is arranged with its axis oriented in a horizontal direction.

The third motor 143 is arranged at a position where the first arm portion 121 is connected to the second arm portion 122. The third motor 143 is arranged with its axis oriented in the horizontal direction. The fourth motor 144 is arranged at a position where the first arm portion 121 is connected to the second arm portion 122. The fourth motor 144 is arranged with its axis oriented in the vertical direction.

The fifth motor 145 is arranged at a position where the second arm portion 122 is connected to the mounting portion 130. The fifth motor 145 is arranged with its axis oriented in the horizontal direction. The sixth motor 146 is arranged at a position where the second arm portion 122 is connected to the mounting portion 130. The sixth motor 146 is arranged with its axis oriented in the vertical direction.

Next, operation of the multi-axis robot 100 will be described. For the multi-axis robot 100, as shown in FIG. 2, as a load weight of a workpiece decreases, the center of the mounting portion 130 can reach a more distant position from the axis of the first motor 141. Specifically, as the load weight of the workpiece decreases the load applied to the second motor 142, the third motor 143, and the sixth motor 146 decreases, and thus, the center of the mounting portion 130 can reach a more distant position from the axis of the first motor 141. Causing the mounting portion 130 to reach a position distant from the axis of the first motor 141 can increase the horizontal distance from the base portion 110 to the mounting portion 130. An increase in the horizontal distance from the base portion 110 to the mounting portion 130 results in an increase in the load torque applied to the second motor 142 and the third motor 143. The load torque applied to the second motor 142 and the third motor 143 increases according to the load weight of the workpiece (not shown) held by the mounting portion 130 (end effector) and the length of the horizontal distance.

In the following embodiment, the operable range of the motors 140 is limited according to the allowable torque of the motors 140 and the load weight. Thus, it is possible to achieve reduction in costs by lowering the specifications of the motors 140.

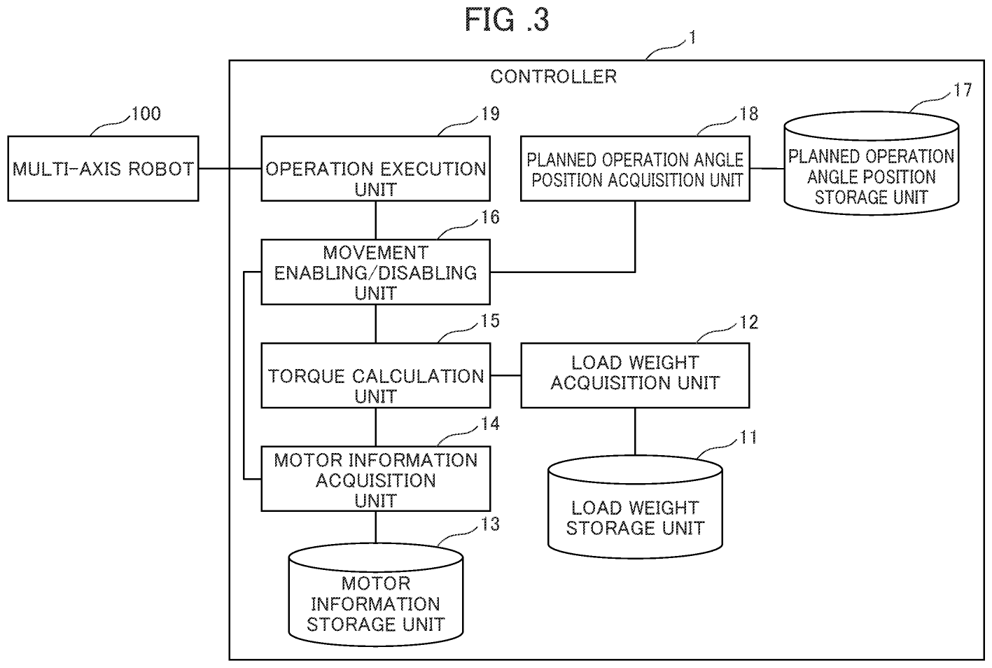

Next, the controller 1 and the program according to an embodiment of the present disclosure will be described. The controller 1 is a device that controls the multi-axis robot 100 that holds the workpiece. The controller 1 controls driving of the motor 140 and operation of the end effector, for example. As shown in FIG. 3, the controller 1 includes a load weight storage unit 11, a load weight acquisition unit 12, a motor information storage unit 13, a motor information acquisition unit 14, a torque calculation unit 15, a movement enabling/disabling determination unit 16, a planned operation angle position storage unit 17, a planned operation angle position acquisition unit 18, and an operation execution unit 19.

The load weight storage unit 11 is a storage medium such as a hard disk. The load weight storage unit 11 stores information on the load weight of the workpiece held by the multi-axis robot 100.

The load weight acquisition unit 12 is implemented by, for example, a CPU in operation. The load weight acquisition unit 12 acquires the load weight of the workpiece. The load weight acquisition unit 12 acquires, for example, the information on the load weight of the workpiece stored in the load weight storage unit 11.

The motor information storage unit 13 is a storage medium such as a hard disk. The motor information storage unit 13 stores, as motor information, the position, the direction of the axis, and the allowable torque of the motors 140. Specifically, the motor information storage unit 13 stores, as the motor information, the position, the direction of the axis, and the allowable torque of each of the motors 140, i.e., each of the first motor 141, the second motor 142, the third motor 143, the fourth motor 144, the fifth motor 145, and the sixth motor 146.

The motor information acquisition unit 14 is implemented by, for example, the CPU in operation. The motor information acquisition unit 14 acquires the motor information. In the present embodiment, the motor information acquisition unit 14 acquires the motor information stored in the motor information storage unit 13.

The torque calculation unit 15 is implemented by, for example, the CPU in operation. The torque calculation unit 15 calculates a load torque applied from the workpiece to the motor 140 of each axis, based on the load weight of the workpiece and the horizontal distance from the axial center of the motor 140 of each axis. The torque calculation unit 15 calculates the load torque applied to the motors 140 based on the acquired motor information and the acquired load weight, for example. Specifically, the torque calculation unit 15 calculates the load torque applied to the motor 140 according to the position of the workpiece (a rotation angle of the motor 140), based on the load weight of the workpiece, the position of the motor 140, the direction of the axis, and the horizontal distance to the workpiece. For example, as shown in FIG. 4, when the load weight of the workpiece is defined as m (kg), an acceleration of gravity is defined as g (m/s²), the horizontal distance from the second motor 142 to the workpiece (mounting portion 130) is defined as L2 (m), and an angle formed by the axial direction of the mounting portion 130 and the horizontal arrangement surface F is defined as θ, the torque calculation unit 15 calculates a load torque T2 applied to the second motor 142 as follows:

T2=L2×mg×cos θ.

The planned operation angle position storage unit 17 is a storage medium such as a hard disk. The planned operation angle position storage unit 17 stores operation content of the motor 140 as a planned operation. The planned operation angle position storage unit 17 stores, as a planned operation angle position, for example, a rotation angle with respect to a reference rotation position of the motor 140 of each of the axes about which the multi-axis robot 100 moves.

The planned operation angle position acquisition unit 18 is implemented by, for example, the CPU in operation. The planned operation angle position acquisition unit 18 acquires the planned operation angle position of the motor of each axis based on the planned movement position of the workpiece. In the present embodiment, the planned operation angle position acquisition unit 18 acquires the operation content stored in the planned operation angle position storage unit 17.

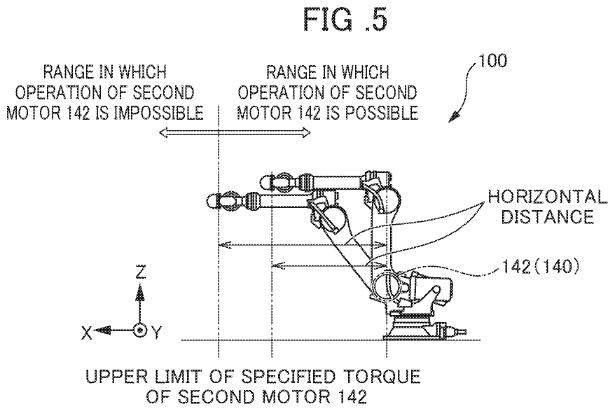

The movement enabling/disabling determination unit 16 is implemented by, for example, the CPU in operation. The movement enabling/disabling determination unit 16 determines, based on a difference between the calculated load torque and the allowable torque of the motor 140, whether the motor 140 can be moved to the planned operation angle position. As shown in FIG. 5, for example, the movement enabling/disabling determination unit 16 determines whether the load torque that increases as the horizontal distance from the motor 140 (second motor 142) to the workpiece increases is within the allowable torque of the motor 140. For example, the movement enabling/disabling determination unit 16 determines whether the increasing load torque is within the allowable torque of the second motor 142 with respect to the planned movement position in a direction radially away from the first motor 141. The movement enabling/disabling determination unit 16 determines that the workpiece cannot be moved to the planned operation angle position when the load torque exceeds the allowable torque. In other words, the movement enabling/disabling determination unit 16 determines that the workpiece cannot be moved to the planned operation angle position when the difference obtained by subtracting the allowable torque from the load torque is positive. On the other hand, the movement enabling/disabling determination unit 16 determines that the workpiece can be moved to the planned operation angle position when the load torque does not exceed the allowable torque. In other words, the movement enabling/disabling determination unit 16 determines that the workpiece can be moved to the planned operation angle position when the difference obtained by subtracting the allowable torque from the load torque is negative.

The operation execution unit 19 is implemented by, for example, the CPU in operation. The operation execution unit 19 stops the operation of the motor 140 when the motor 140 cannot be moved to the planned operation angle position. For example, when the load torque at the acquired planned operation angle position exceeds the allowable torque, the operation execution unit 19 stops the operation of the multi-axis robot 100. On the other hand, when the load torque at the acquired planned operation angle position does not exceed the allowable torque, the operation execution unit 19 executes the operation of the multi-axis robot 100.

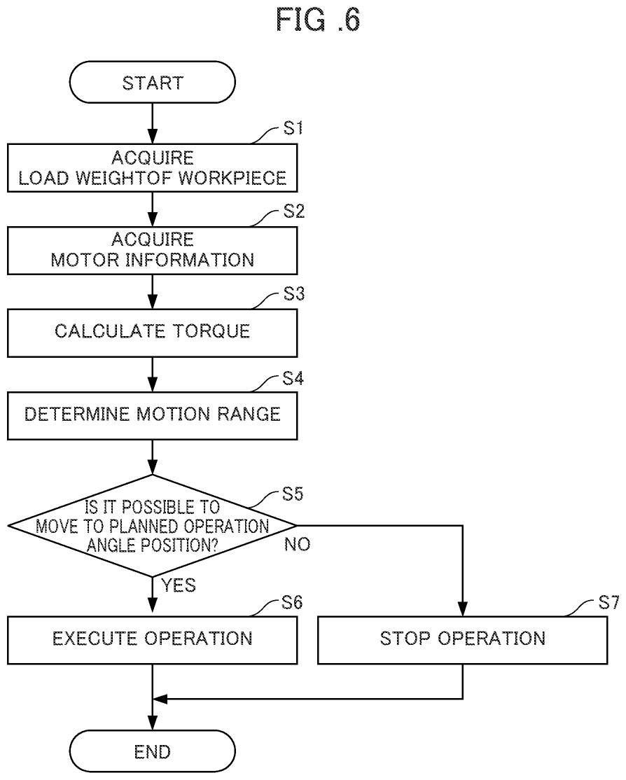

Next, an operation flow of the controller 1 according to the present embodiment will be described with reference to a flowchart of FIG. 6. First, the load weight acquisition unit 12 acquires a load weight of the workpiece (Step S1). Next, the motor information acquisition unit 14 acquired a motor information (Step S2).

Next, a torque information calculation unit calculates, based on the acquired load weight, the motor information, and the planned operation angle position, a load torque generated on each axis of the motor 140 by the acquired load weight (Step S3). Next, the planned operation angle position acquisition unit 18 acquires a planned operation angle position of the motor 140 of each axis for moving the workpiece (Step S4).

Next, the movement possibility enabling/disabling unit 16 determines whether the motor 140 can be moved with respect to the acquired planned operation angle position (Step S5). When the motor 140 can be moved (Step S5: YES), the operation execution unit 19 executes the operation of the multi-axis robot 100 (Step S6). Thus, the process by this flow ends. On the other hand, when the motor 140 cannot be moved (Step S5: NO), the operation execution unit 19 stops the operation of the multi-axis robot 100. Thus, the process by this flow ends.

Next, the program of the present disclosure will be described. Each of the components included in the controller 1 can be implemented by hardware, software, or a combination thereof. Here, implementation by software means that a computer reads and executes a program for the implementation.

The program can be stored in various types of non-transitory computer readable media and can be provided to a computer. Non-transitory computer readable media include various types of tangible storage media. Examples of non-transitory computer readable media include magnetic storage media (such as flexible disks, magnetic tapes, or hard disk drives), optical magnetic storage media (e.g., magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using various types of transitory computer readable media. Examples of transitory computer readable media include electric signals, optical signals, and electromagnetic waves. Transitory computer readable media can provide the program to a computer via a wired communication channel (e.g., electric wires, and optical fibers) or a wireless communication channel.

The controller 1 and the program according to the present embodiment described above exert the following effects.

(1) The controller 1 that controls a multi-axis robot 100 configured to hold a workpiece, the controller 1 including: the planned operation angle position acquisition unit 18 that acquires the planned operation angle position of the motor 140 of each axis, based on the planned movement position of the workpiece; the torque calculation unit 15 that calculates the load torque applied from the workpiece to the motor 140, based on the load weight of the workpiece and the horizontal distance from the axial center of each axis to the workpiece; and the movement enabling/disabling unit 16 that determines, based on the difference between the calculated load torque and the allowable torque of the motor 140, whether to allow the motor 140 to move to the planned operation angle position.

Further, the program that causes a computer to operate as the controller 1 of the multi-axis robot 100 configured to hold the workpiece, the program causing the computer to function as: the planned operation angle position acquisition unit 18 that acquires the planned operation angle position of the motor of each axis, based on the planned movement position of the workpiece; the torque calculation unit 15 that calculates the load torque applied from the workpiece to the motor 140, based on the load weight of the workpiece and the horizontal distance from the axial center of each axis to the workpiece; and the movement enabling/disabling determination unit 16 that determines, based on the difference between the calculated load torque and the allowable torque of the motor 140, whether to allow the motor 140 to move to the planned operation angle position. Thus, when only a light load can be handled in a posture in which the arm portion 120 extended to approximately the maximum and a heavy load is handled only in the posture in which the arm portion 120 is withdrawn, the specifications of the motors 140 can be lowered, and thus the reduction in costs can be achieved. As another effect, it is possible to handle a workpiece having a weight greater than the rated load only when the multi-axis robot 100 has the posture in which the arm portion 120 is withdrawn, while maintaining the rated load of the multi-axis robot 100. Therefore, it is possible to improve the specifications in the posture in which the arm is withdrawn.

(2) The controller 1 further includes the operation execution unit 19 that stops operation of the motor 140 when the motor 140 is not allowed to move to the planned operation angle position. Thus, it is possible to prevent the motor 140 from being applied with a load equal to or greater than the allowable torque. Therefore, the operation of the multi-axis robot 100 can be stabilized.

Although preferred embodiments of the controller 1 and the program of the present disclosure have been described above, the present disclosure is not limited to the above-described embodiments and can be appropriately modified. For example, in the above embodiments, the controller 1 includes the load weight storage unit 11, but is not limited thereto. The load weight acquisition unit 12 may acquire the load weight from an exterior device instead of the load weight storage unit 11. Further, the controller 1 may further include a measuring unit (not shown) that measures the load weight of the workpiece.

In the above embodiments, the multi-axis robot 100 may be arranged with respect to a vertical surface, such as a wall, as a reference surface. In this case, the controller 1 may further determine a motion range for the first motor 141 that moves against gravity, as shown in FIG. 6. In other words, the controller 1 may determine the motion range for the motor 140 that rotates against gravity, from the load weight of the workpiece.

In the above embodiments, the controller 1 may further include an output unit (not shown) that outputs to the outside that the operation execution unit 19 has stopped the operation. The output unit may output to the outside that the operation execution unit 19 has stopped the operation by using a voice, and an image, or an optical signal, for example.

In the above embodiments, the center of gravity of the workpiece has been described as being at the center of the mounting portion 130 (flange center). On the other hand, when the center of gravity of the workpiece is not at the center of the mounting portion 130 (flange center), the torque calculation unit 15 may calculate the load torque applied from the workpiece to the motor 140, based on the horizontal distance between the position of the center of gravity of the workpiece and the position of each axis of the motor 140.

### EXPLANATION OF REFERENCE NUMERALS

1: Controller
15: Torque calculation unit
16: Motion range determination unit
19: Control execution unit
100: Multi-axis robot
140: Motor

1. A controller that controls a multi-axis robot configured to hold a workpiece, the controller comprising:
a planned operation angle position acquisition unit that acquires a planned operation angle position of a motor of each axis, based on a planned movement position of the workpiece;
a torque calculation unit that calculates a load torque applied from the workpiece to the motor, based on a load weight of the workpiece and a horizontal distance from an axial center of each axis to the workpiece; and
a movement enabling/disabling determination unit that determines, based on a difference between calculated load torque and an allowable torque of the motor, whether to allow the motor to move to the planned operation angle position.

2. The controller according to claim 1, further comprising
a measuring unit that measures the load weight of the workpiece.

3. The controller according to claim 1, further comprising
an operation execution unit that stops operation of the motor when the motor is not allowed to move to the planned operation angle position.

4. A non-transitory computer readable media which non-transitorily stores a program that causes a computer to operate as a controller of a multi-axis robot configured to hold a workpiece, the program causing the computer to function as:
a planned operation angle position acquisition unit that acquires a planned operation angle position of a motor of each axis, based on a planned movement position of the workpiece;
a torque calculation unit that calculates a load torque applied from the workpiece to the motor, based on a load weight of the workpiece and a horizontal distance from an axial center of each axis to the workpiece; and
a movement enabling/disabling determination unit that determines, based on a difference between calculated load torque and an allowable torque of the motor, whether to allow the motor to move to the planned operation angle position.
